(19) United States
(12) Patent Application Publication
(10) Pub. No.: US 2004/0164438 A1
(43) Pub. Date: Aug. 26, 2004

(54) Slurry composition and method for forming friction material therefrom

(75) Inventor: Robert Anthony Lamport, Centerville, OH (US)

Correspondence Address: Scott A. McBain, Esq., Delphi Technologies Inc., Legal Staff, Mail Code 480-410-202, P.O. Box 5052, Troy, MI, 48007-5052, US

(73) Assignee: Delphi Technologies, Inc., Troy, MI

(21) Appl. No.: 10/375,748

(22) Filed: Feb. 26, 2003

(51) Int. Cl. C09K 3/14

(52) U.S. Cl. 264/86; 106/36

(57) ABSTRACT

A slurry composition and a method for producing a friction material from the slurry composition, wherein long fiber lengths and large particle sizes are incorporated without fracture and without a high content of pulp and other processing aids. The slurry comprises water and 10-50% by weight solids, the solids comprising 2-15 vol. % organic fibers of 2-15 mm length, 2-20 vol. % organic pulp of up to 8 mm length, 2-10 vol. % inorganic fibers of 2-15 mm length, 2-15 vol. % metallic fibers of 2-15 mm length, 2-10 vol. % inorganic flake materials of ½-10 mm in the largest dimension, 5-20 vol. % carbonaceous particles of ½-10 mm in the largest dimension, and resin binder. The slurry is placed in a die cavity, and the water from the slurry is extracted by pressing on the slurry in the die cavity with a die punch sized to form a gap between the punch and the die sidewall. The water is extracted through the gap, followed by drying, resulting in the formation of a friction material preform, which is then molded by applying heat and pressure.

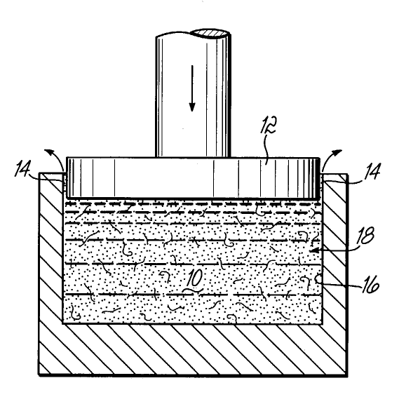

### FIELD OF THE INVENTION

The present invention relates to a friction material slurry composition formulated for use in the production of molded friction materials. These materials are suitable for use in the brake mechanisms of automobiles, aircraft, railroad vehicles, industrial machines, etc., for example as brake pad material.

### BACKGROUND OF THE INVENTION

The friction material industry has long recognized the need to eliminate asbestos in friction materials due to health, environmental and safety hazards attributed to asbestos. Numerous approaches to the replacement of asbestos have led to a substantial body of technology and prior art that has resulted in at least two major categories of non-asbestos formulations, namely semi-metallic materials and organic non-asbestos (NAO) materials.

The elimination of asbestos from friction material formulations, although relatively successful, has various limitations and disadvantages with respect to difficulty in preforming and processing blends of ingredients, reduced strength and toughness, reduced physical and frictional performance and reduced thermal stability.

Virtually all known disc brake manufacturing involves dry blending of constituents. For low bulk density materials, a preform is generally made from a pre-measured weight of brake material. Brake pads, for example, are produced by dry blending friction and lubricating particles, fibers and fillers in a resin matrix, forming the blended material into pucks, and then heating under pressure in a mold. This method of processing is extremely sensitive to changes in composition of the brake compound. It also severely restricts the size of constituents that may be used. For example, fiber length is limited to what may be efficiently dispersed in the blender. For most fibers, the size is typically limited to less than 0.5-1 mm, depending on the mixer configuration. Many of the fibers used for reinforcement in the friction material are intrinsically brittle, and upon fracture, lose their reinforcing capability. Brittle fibers typically experience significant fiber breakage associated with the high sheer necessary to disperse the fibers in the dry blend. It is also difficult to produce friction material pads having complex shapes due to the material limitations.

Particle sizes of ingredients are similarly restricted because the mechanical agitation associated with transporting and metering of the mix into the die cavity causes drastic segregation. To incorporate larger particles, additional processing steps, such as precoating the heavy phases with a sticky liquid resin, must be employed. This greatly lengthens the batch mix time, and typically requires a solvent recovery system. Large percentages of high-surface area pulp may also be required to improve the segregation resistance of the mix, and to improve preform strength. Frequently, 25% or more of the compound is included strictly for improved processability during manufacture. For example, organic pulp is often included in an amount greater than 20% of the formulation. This contributes significantly to the low thermal stability of the braking component, because these organic processing aids are not thermally stable at the high, abusive temperatures experienced by the braking components.

Paper making processes have also been used to produce friction material in the form of a long or continuous sheet of paper. The paper is then folded and/or cut and stacked to form a laminated friction material preform, which is then hot pressed or molded to form the friction material pad. This laminated oriented fiber friction material (LOFFM) process is described, for example, in U.S. Pat. Nos. 6,162,315 and 5,894,049. While the wet slurry process used for forming the sheet of paper has expanded the potential materials that may be used to form the friction material compared to the dry blending process, such as increased fiber lengths and particles sizes, the materials are still quite limited by the thin dimension of the paper, and the sheet forming and laminating process is significantly more involved and time consuming than the dry blending process.

There is thus a need for an improved process and material composition that eliminates or reduces the restrictions on particle and fiber sizes and limits the content of the organic processing aids that decrease the thermal stability of the braking component.

### SUMMARY OF THE INVENTION

The present invention provides a slurry composition for a wet, slurry-processed friction material, and a method for producing a friction material from the slurry composition, wherein long fiber lengths and large particle sizes may be incorporated without fracture and without a high content of pulp and other processing aids. The slurry comprises water and 10-50% by weight solids, the solids comprising 2-15 vol. % organic fibers of 2-15 mm length, 2-15 vol. % organic pulp of up to 8 mm length, 2-10 vol. % inorganic fibers of 2-15 mm length, 2-15 vol. % metallic fibers of 2-15 mm length, 2-10 vol. % inorganic flake materials of ½-10 mm in the largest dimension, 5-20 vol. % carbonaceous particles of ½-10 mm in the largest dimension, and resin binder. The slurry is placed in a die cavity, and the water from the slurry is extracted by pressing on the slurry in the die cavity with a die punch sized to form a gap between the punch and the die sidewall. The water is extracted through the gap, resulting in the formation of a friction material preform, which is then molded by applying heat and pressure.

### BRIEF DESCRIPTION OF THE DRAWINGS

The present invention will now be described, by way of example, with reference to the accompanying drawing, in which:

The FIGURE is a schematic cross-sectional view of a die cavity and die punch configuration for performing the method of the present invention.

### DETAILED DESCRIPTION

The present invention provides a water slurry composition for a wet slurry process material having a solids content in the range of 10-50% by weight, and advantageously 20-40% by weight, and a method for forming a molded friction material from the slurry composition. By mixing the ingredients as a water slurry, the limitations of particle size and fiber length are effectively eliminated, as is the need for a high content of organic processing aids and liquid resins. The wet slurry mixing process has the ability to disperse long fibers and flakes and to suspend large particles without segregation. In accordance with the present invention, fibers up to 15 mm in length and particles and flakes up to 10 mm in the largest dimension may be dispersed in the slurry composition and suspended without segregation. The incorporation of longer fibers permits accurate control of stiffness and thermal conductivity and a much higher preform and pad strength. The utilization of larger carbonaceous particles improves wear life. The use of large flake materials also reduces open porosity, and thus moisture pickup, thereby improving water recovery friction characteristics. The necessary rubber content may also be reduced in the formulation, which further improves high temperature performance. Significantly, the organic pulp content is limited to 15% by volume or less of the total solids content, and advantageously 10-15% by volume, in large part by virtue of the high solids content of the slurry composition, which has a marked effect on the thermal stability of the braking components.

The solids content of the slurry composition of the present invention includes organic fibers in an amount of 2-15 vol. %. The fibers have a length of 2-15 mm and may be, for example, para-aramid fibers, polyacrylonitrile (PAN) fibers, pitch-based carbon/graphite fibers (pitch), oxidized/carbonized/graphitized polymer precursor fibers or polybenzimidazole (PBI) fibers. It may be understood that pitch fibers are produced from the sludge left over after distilling petroleum crude or coal. When sufficiently heated, most of the remaining long-chain hydrocarbons are driven off, and what remains is carbon, which can be extruded into filaments. If heated in a vacuum of sufficiently high temperature, the glassy carbon may be converted to a graphitic structure. The oxidized/carbonized/graphitized polymer precursor fibers may be understood to refer to carbon fibers produced with a high carbon content polymer precursor, such as PAN, where the fibers are spun into a continuous filament, then oxidized to stabilize the polymer. Higher temperatures and inner atmosphere may result in even higher carbon content to carbonize the polymer precursor, and even further heat treatment will produce graphite fiber. Exemplary fibers include PANEX® products available from Zoltek Corp.

The solids content of the slurry composition further includes 2-20 vol. % organic pulps having a fiber length up to 8 mm, and advantageously ¼-4 mm. The organic pulps may be, for example, para-aramid, PAN or oxidized PAN. It may be appreciated that pulp refers to cellulose fibers or fibrillated synthetic fibers. Advantageously, the pulp content is limited to 5-10 vol. %, which may be achieved by virtue of the high solids content of the slurry. Limiting the pulp content will have the effect of improving the thermal stability of the friction material. Exemplary pulps include Kevlar® products available from E. I. du Pont de Nemours (Wilmington, Del.) or Twaron® products available from Teijin Twaron (Japan) (previously from Enka B. V. Corp.)

The solids content of the slurry composition further includes inorganic fibers in an amount of 2-10 vol. %. The fibers have a length of 2-15 mm, and may, for example, be fiberglass, melt spun mineral glass (Rockwool), basalt wool, or crystalline ceramic wool. Exemplary fibers include Fibrox® products from Fibrox Technologies (Canada). The composition is essentially free of asbestos fibers, i.e., there is no intentional addition of asbestos.

The solids content of the slurry composition further comprises metallic fibers in an amount of 2-15 vol. %. The fibers have a length of 2-15 mm, and may, for example, comprise copper, brass, bronze, ferrous alloys, aluminum or aluminum alloys, or titanium-based alloys. Exemplary metallic fibers are available from International Steel Wool Co. (Springfield, Ohio).

The solids content of the slurry composition further comprises inorganic flake materials in an amount of 2-10 vol. %. The flake materials have a diameter, as measured in the largest dimension, of ½-10 mm, and may, for example, comprise delaminated mica, vermiculite or graphite. Mica products, for example, are available from Suzorite Mica Products, Inc. (Canada).

The solids content of the slurry composition further comprises large carbonaceous particles in an amount of 5-20 vol. %. The particles have a size in the largest dimension of ½-10 mm, and may, for example, comprise coke, pitch-densified coke, metallurgical coke, secondary artificial graphite, natural amorphous graphite or extruded carbon-based rod. Carbonaceous products may be obtained from Asbury Graphite, Sales or Great Lakes Carbon, for example.

The solids content of the slurry composition further comprises a binder, such as a phenolic resin. The resin may be present in an amount of 12-25 vol. %. Other examples of binding agents suitable for use in the slurry composition of the present invention include formaldehyde resin, melamine resin, epoxy resin, acrylic resin, aromatic polyester resin or urea resin, polyamide resin, polyphenylene-sulfide resin, polyether resin, polyimide resin or polyether-ether-ketone resin.

The solids content of the slurry composition may also include various organic and inorganic fillers. Commonly used organic fillers include fine rubber (dust or crumb) and/or cashew-based particles (dust or crumb). The content of the organic fillers may be adjusted as desired. The various inorganic fillers may function as friction modifiers, antioxidants and/or abrasives. These filler particles generally have a diameter less than 0.05 mm, and may include such materials as potassium titanates (potassium hexatitanate, potassium octatitanate, potassium trititanate, potassium magnesium titanate, potassium lithium titanate, etc.), zirconium silicate, zirconia, barium sulphate, calcium carbonate and various other ceramic materials. The inorganic filler may be added in an amount to achieve 100% of the desired solids content after inclusion of all other desired materials.

By way of example and not limitation, an exemplary solids content formulation for a slurry composition of the present invention is provided in the following table.

| | | Content |
|---|---|---|
| General Component | Specific Material | (vol. % of solids) |
| Organic Fibers | 2-6 mm Carbon Fiber | 2-6% |
| Organic Pulps | Aramid Pulp | 2-10% |
| Inorganic Fibers | 0.5-4 mm Rockwool | 3-8% |
| Metallic Fibers | 1-6 mm Copper Fiber | 2.5-6% |
| Inorganic Flake Material | Large Flake Mica | 6% |
| Large Carbonaceous | 0.5-2 mm Graphite | 8-13% |
| Particles | | |
| Inorganic Fillers: Friction | K₂Ti₆O₁₃ | 14% |
| Modifiers/Antioxidants/ | ZrSiO₄ | 7% |
| Abrasives | Sb₂S₃ | 2% |
| | <0.5 mm BaSO₄, | 6% |
| | CaCO₃, etc. | |
| Organic Fillers | fine rubber | 8% |
| | cashew-based particles | 8% |
| Binder | phenolic resin | 18% |

This solids content formulation is then mixed in accordance with the method of the present invention into a slurry with water such that the solid content comprises 10-50% by weight of the slurry composition. The slurry material is then pressed to remove the majority of water, and the remainder of water is removed by forced air drying to form a preform. The preform material is then molded in a die cavity of, for example, a platen press, a rotary hot eject integrally molded (HEIM) apparatus, a book mold or a positive cavity mold. These apparatuses and other like apparatuses mold the preform either to a desired volume or to a desired pressure.

Referring to the FIGURE, the majority of water is removed from the slurry 10 by use of a die punch 12 that forms a small gap 14 between the punch 12 and the die sidewall 16 such that the water is squeezed out of the die cavity 18 through the gap 14, as indicated by the arrows. Conventional slurry processing uses a bottom screen or permeable bottom or side wall for draining the water or solvent, which may result in the escape of fine particles and fibers through the screen openings. Bottom suction is also commonly used, which further increases particle and fiber loss, thereby altering the composition. Use of the gap method of the present invention for squeezing out the water content maintains the fines. After drying, such as in a forced air oven, to remove any remaining water, the preform composition can then be formed into a pad of desired shape and thickness by the application of heat and pressure. The molding process using the slurry composition of the present invention is significantly simpler and less expensive than the laminated oriented fiber friction material (LOFFM) process, such as that disclosed in U.S. Pat. Nos. 6,162,315 and 5,894,049. The LOFFM process uses a slurry that is formed into a continuous sheet and the particles are aligned in the sheet direction. The sheets are then stacked into a laminate and molded to form the friction material. The simplified process of the present invention allows for numerous part configurations to be produced, including hard-to-make shapes that are difficult or impossible to produce using conventional dry-blending processes, and without the need for the cutting and laminating of the LOFFM process.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of the general inventive concept.

What is claimed is:

1. A slurry composition for a wet, slurry-processed friction material, comprising water and 10-50% by weight solids, the solids comprising:
2-15 vol. % organic fibers of 2-15 mm length;
2-20 vol. % organic pulp of up to 8 mm length;
2-10 vol. % inorganic fibers of 2-15 mm length;
2-15 vol. % metallic fibers of 2-15 mm length;
2-10 vol. % inorganic flake materials of ½-10 mm in the largest dimension;
5-20 vol. % carbonaceous particles of ½-10 mm in the largest dimension; and
resin binder.

2. The slurry composition of claim 1 wherein the organic fibers are selected from the group consisting of: para-aramids, polyacrylonitriles, pitch, oxidized polymer precursor, carbonized polymer precursor, graphitized polymer precursor and polybenzimidazole.

3. The slurry composition of claim 1 wherein the organic pulp comprises fibrillated fibers selected from the group consisting of: para-aramids, polyacrylonitriles and oxidized polyacrylonitriles.

4. The slurry composition of claim 1 wherein the organic pulp is 5-10% of the solids.

5. The slurry composition of claim 1 wherein the solids comprise 20-40 wt. % of the slurry composition.

6. The slurry composition of claim 1 wherein the inorganic fibers are selected from the group consisting of: fiberglass, melt spun mineral glass, basalt wool, and crystalline ceramic wool.

7. The slurry composition of claim 1 wherein the metallic fibers are selected from the group consisting of: copper, brass, bronze, ferrous alloys, aluminum alloys and titanium alloys.

8. The slurry composition of claim 1 wherein the inorganic flake materials are selected from the group consisting of: delaminated mica, vermiculite and graphite.

9. The slurry composition of claim 1 wherein the carbonaceous particles are selected from the group consisting of: coke, pitch-densified coke, metallurgical coke, secondary artificial graphite, natural amorphous graphite and extruded carbon-based rod.

10. The slurry composition of claim 1 wherein the resin is a phenolic-based resin.

11. The slurry composition of claim 1 further comprising a potassium titanate inorganic filler.

12. The slurry composition of claim 1 further comprising a zirconium silicate abrasive inorganic filler.

13. The slurry composition of claim 1 further comprising antimony sulphide friction stabilizer.

14. The slurry composition of claim 1 further comprising an inorganic filler of particle diameter less than 0.05 mm and selected from the group consisting of barium sulphate and calcium carbonate.

15. The slurry composition of claim 1 further comprising at least one organic filler selected from rubber and cashew-based particles.

16. A slurry composition for a wet slurry processed friction material, comprising water and 20-40% by weight solids, the solids comprising:
2-15 vol. % organic fibers of 2-15 mm length;
5-10 vol. % organic pulp of ¼-4 mm length;
2-10 vol. % inorganic fibers of 2-15 mm length;
2-15 vol. % metallic fibers of 2-15 mm length;
2-10 vol. % inorganic flake materials of ½-10 mm in the largest dimension;
5-20 vol. % carbonaceous particles of ½-10 mm in the largest dimension;
12-25 vol. % resin binder; and
the balance being at least one filler selected from the group consisting of potassium titanates, zirconium silicate, zirconia, barium sulphate, calcium carbonate, rubber particles and cashew particles.

17. The slurry composition of claim 16 wherein the organic fibers are selected from the group consisting of: para-aramids, polyacrylonitriles, pitch, oxidized polymer precursor, carbonized polymer precursor, graphitized polymer precursor and polybenzimidazole.

18. The slurry composition of claim 16 wherein the organic pulp comprises fibrillated fibers selected from the group consisting of: para-aramids, polyacrylonitriles and oxidized polyacrylonitriles.

19. The slurry composition of claim 16 wherein the inorganic fibers are selected from the group consisting of: fiberglass, melt spun mineral glass, basalt wool, and crystalline ceramic wool.

20. The slurry composition of claim 16 wherein the metallic fibers are selected from the group consisting of: copper, brass, bronze, ferrous alloys, aluminum alloys and titanium alloys.

21. The slurry composition of claim 16 wherein the inorganic flake materials are selected from the group consisting of: delaminated mica, vermiculite and graphite.

22. The slurry composition of claim 16 wherein the carbonaceous particles are selected from the group consisting of: coke, pitch-densified coke, metallurgical coke, secondary artificial graphite, natural amorphous graphite and extruded carbon-based rod.

23. The slurry composition of claim 16 wherein the resin is a phenolic-based resin.

24. A method of forming a molded friction material, comprising:
placing a slurry composition in a die cavity, the slurry composition comprising water and 10-50% by weight solids, the solids comprising 2-15 vol. % organic fibers of 2-15 mm length, 2-20 vol. % organic pulp of up to 8 mm length, 2-10 vol. % inorganic fibers of 2-15 mm length, 2-15 vol. % metallic fibers of 2-15 mm length, 2-10 vol. % inorganic flake materials of ½-10 mm in the largest dimension, 5-20 vol. % carbonaceous particles of ½-10 mm in the largest dimension, and resin binder;
extracting the water from the slurry by pressing on the slurry in the die cavity with a die punch sized to form a gap between the punch and a sidewall of the die cavity whereby the water is extracted through the gap, followed by drying, resulting in the formation of a friction material preform; and
molding the friction material preform by applying heat and pressure thereto.

25. The method of claim 24 wherein the friction material preform is molded in a platen press apparatus.

26. The method of claim 24 wherein the friction material preform is molded to a specified volume.

27. The method of claim 24 wherein the friction material preform is molded to a specified pressure.
